(19) United States
(12) Patent Application Publication
(10) Pub. No.: US 2005/0028155 A1
(43) Pub. Date: Feb. 3, 2005

(54) Java execution device and Java execution method

(75) Inventor: Un-gyo Jung, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/621,446

(22) Filed: Jul. 18, 2003

(30) Foreign Application Priority Data
Dec. 2, 2002 (KR) 2002-76041

(51) Int. Cl. G06F 9/455

(52) U.S. Cl. 718/1

(57) ABSTRACT

A Java execution device, a Java class file configuration, a Java execution method, a method of precompiling a Java file, and an execution method in a Java Virtual Machine (JVM) are provided. The Java execution device includes an extended class library, which includes a class file of a machine code obtained by precompiling a class file included in a standard class library, and a Java Virtual Machine (JVM), which executes the class file of the machine code or an application file included in the extended class library. Thus, it is possible to improve the performance of the Java platform while assuring platform-independency and dynamic extensibility of the Java platform.

### CROSS REFERENCES TO RELATED APPLICATIONS

This application claims the priority of Korean Patent Application No. 10-2002-76041, filed on Dec. 2, 2002, in the Korean Intellectual Property Office, the disclosure of which is incorporated herein in its entirety by reference.

### BACKGROUND OF THE INVENTION

1. Field of the Invention

The present invention relates to a Java platform, and more particularly, to a Java execution device, configuration of a Java class file, Java execution method, method of precompiling a Java file, and an execution method in a Java Virtual Machine (JVM).

2. Description of the Related Art

Due to a need for a platform-independent language to be used by software included in various electronic devices and products, for example, microwave ovens or remote controls, a Java language was introduced by Sun Microsystems, Inc.

In order to create a platform-independent execution file, Java compiles source codes into Java bytecodes, and the Java bytecodes are executed on a Java Virtual Machine (JVM). As shown in FIG. 1, a Java program 110 in java format is compiled into a Java execution file in class format by a compiler 120. This Java execution file in class format is interpreted by an interpreter 130 residing inside the JVM and is executed. The JVM performs 3 steps, that is, class loading, where all classes required for program execution are loaded; verification, where class file formats, access authorization and data format conversion are tested; and program execution.

FIG. 2 shows a hierarchical structure of a Java platform which executes a Java program 240. The hierarchical structure includes the Java program 240 written in the Java language; the Java platform having a Java Virtual Machine (JVM) 220 and a Java API 230; and a hardware-dependent platform 210. Since the Java execution file is a class file including platform-neutral execution codes, i.e., Java bytecodes, the Java execution file can be executed only if a Java runtime environment (JRE) is provided, regardless of the system on which the Java execution file was developed.

Java has been widely used since it has many advantages, such as platform-neutrality assuring characteristics of write once run anywhere (WORA), dynamic extensibility, and the like. Java is widely used as server technology for web services, and, in most cases, web application servers are based on Java. In addition, in embedded devices, Java is introduced to environments in which user services are provided or a control application is executed. In particular, MexE used for mobile phones, MHP used for digital TVs, DASE, OCAP, and the like are standard specifications which define application environments of the embedded devices as Java-based environments. Therefore, it is obvious that Java will be more widely used in markets for embedded devices.

Although Java has been widely used for various purposes, a Java application does not exhibit satisfactory performance compared to a native application.

Recently, many methods for solving problems related to the performance of Java have been developed, and as a result, some benefits have come about. These methods improve the efficiency of an interpreting method used in a conventional JVM by compiling a Java bytecode used in the methods into machine codes, and they can be classified into three types as follows.

A first type is a Just-In-Time (JIT) compiling method. In JIT compilation, methods invoked at a method calling point, during execution of a Java application of the JVM, are compiled into the machine codes, and the machine codes, instead of the Java bytecodes, are directly executed.

Although JIT compilation executes Java more quickly than the interpreting method, it needs random access memory (RAM) of a number of megabytes in addition to a memory used by the Java application, because a considerable amount of memory is needed in JIT compilation and the machine codes obtained by compiling methods have to be maintained in the memory so that the machine codes can be used again another time. In addition, since the JIT compiling method compiles all methods invoked during execution of the Java application, overhead caused by JIT compilation during execution of the Java application becomes great. An Open Runtime Platform (ORP) is one type of JVM using JIT compilation, which was developed by Intel Corporation during research.

A second type is a dynamic adaptive compiling method. Dynamic adaptive compilation adopts both the JIT compiling method and the interpreting method. In dynamic adaptive compilation, only “hot” methods having a great influence on the performance of the Java platform are compiled, and the other methods are compiled by using the interpreting method. In order to determine which methods are hot methods, profiling is performed during execution of the Java application by using various methods such as a method of determining the hot methods if the number of methods being invoked is greater than a predetermined number. FIG. 3 is a general configuration of a Java platform 300 using dynamic adaptive compilation. The Java platform 300 includes a class library 320 and a Java Virtual Machine (JVM) 330. The JVM 330 includes a JIT compiler 340, an interpreter 350 for executing a method which does not perform JIT compilation, a class loader 360 for loading a required class from a class file, and a runtime system 370 for maintaining a data structure required during execution of the Java application, such as a method region, a Java stack, and the like, and for combining and managing whole components.

FIG. 4 is a typical flowchart of executing one method in a JVM using dynamic adaptive compilation. Once the method is invoked in step S410, it is determined whether the method has already been JIT compiled and has machine codes in step S420. If the method has already been compiled by the JIT compiling method, the machine code is executed in step S460, and the process returns in step S480. If the method has not been JIT compiled, profile information on the invoked method is brought and updated in step S430. Then, it is determined whether the invoked method is a hot method based on the profile information in step S440. If the invoked method is a hot method, information on the method is transmitted to a JIT compiler, and Java bytecodes of the method are JIT compiled in step S450. A target machine code obtained by the JIT compilation is then executed in step S460 as a result of the JIT compilation. If the invoked method is not the hot method, the information on the invoked method is transmitted to an interpreter, and the invoked method is executed in step S470. After execution of the invoked method is complete, the process returns to a time point before when the method is invoked. The flowchart in FIG. 4 can also be applied to another method invoked during execution of the method.

Since the JVM using dynamic adaptive compilation compiles only a part of all executed methods, latency due to compilation of all executed methods is smaller than that in JIT compilation. Since the number of machine codes to be maintained is small, a load on the memory become relatively smaller. However, since the methods other than the hot methods are executed after being interpreted, the methods need the interpreter as well as JIT compilation, and profiling performed to determine the hot methods causes overhead during execution of the Java application. There are advantages and disadvantages in the JIT compiling method and the dynamic adaptive compiling method. However, in most cases, the dynamic adaptive compiling method is more frequently used in embedded devices having memory of a limited capacity. CVM of Sun Microsystems, Inc. or Jeode of Insignia Systems, Inc., or the like utilize the dynamic adaptive compiling method.

A third type is an Ahead-Of-Time (AOT) compiling method. The JIT compiler included in the JVM operates during the execution of the Java application. However, an Ahead-Of-Time (AOT) compiler is separated from the JVM and is used independently from the JVM. The AOT compiler is used in an application developing environment. In general, an execution file, which can be executed in a target device, is created by compiling a Java class file. FIG. 5 shows a general procedure of using the AOT compiler.

An application file 510 in a Java source file or a class file format is compiled into an object file 540 by an AOT compiler 520, so that the application file 510 can be used in the target device where the Java application will be executed. Here, a library class 530 necessary for the execution of the Java application is also compiled with the application file 510. An execution file 570, which can be independently executed in the target device, is created by linking the object file 540 with a runtime system module 560 via a linker 550. The runtime system module 560 is used to provide various functions of the JVM other than a bytecode execution engine and provides functions such as garbage collection, type reflection, or the like.

This third type is distinctively different from the first and second types. The AOT compiling method creates the execution file that is dependent on a target environment by processing a program written in Java in the same manner as processing a program written in C/C++. The first and second types distribute the Java application in a standard Java execution file format, i.e., a class file, and perform a compilation on the JVM when the Java application is executed in the target device. However, the AOT compiling method performs compilation in a development platform and distributes the Java application after compiling the Java class file into an execution file that can be executed in the target environment.

Because of such differences among the three types of methods, two important advantages become useless if the AOT compiling method is used.

When the AOT compiling method is used, the most important advantage rendered useless is the platform-independency of Java. Since Java is distributed in execution code format used for the JVM, i.e., a class file having Java bytecodes, Java can be executed by the JVM in any target hardware platform by using the JVM. However, if the Java is compiled into a machine code which can be executed only in a particular hardware using AOT compilation, it is not possible to execute the Java application in other machines.

In addition, a characteristic of dynamic extensibility is lost in AOT compilation. Dynamic extensibility allows Java to recognize and use a new type of execution code during the execution of the Java application and is a special function exclusive to Java as compared, for example, to C/C++. A general AOT compiling method creates an object file by simultaneously compiling an application class and a library class that is used by the application and cannot load and execute a new class outside the object file other than the application class and the library class included in the object file during the execution of the Java application.

Although, the AOT compiling method loses important advantages of Java as described above, it is possible to create an execution file showing rapid performance capabilities by applying optimization techniques since compilation is performed, before the application is distributed under a development environment. Thus, the AOT compiling method is used when a target Java running environment is prescribed and the speed of the execution of the Java application is a very important factor. GCJ, part of the GNU Compiler Collection, corresponds to an AOT compiler.

Since the above three types have different advantages, disadvantages, and characteristics from one another, each method, which is optimal for a target Java running environment and a purpose of a target machine, is selected when the Java platform is installed in the target machine. However, Java has had many problems related to its performance. In particular, it is difficult to use JIT compilation in an embedded device due to a limitation of memory. Thus, the applicability of Java is limited.

### SUMMARY OF THE INVENTION

The present invention provides a Java execution device, a configuration of a Java class file, a Java execution method, a method of precompiling a Java file, and an execution method in a Java Virtual Machine (JVM), which are capable of improving the performance of a Java platform while assuring platform-independency and dynamic extensibility of the Java platform.

In most cases, a code executed to operate a Java application corresponds to a class library code included in a Java platform rather than an application code provided by an application developer and requires much more time to be executed than the application code. In addition, a Java application class has to be distributed in java class file format so as to be executed in any machine. However, since the class library code is previously installed in a particular machine with the JVM, it doesn't matter whether the class library code is dependent on a hardware.

Therefore, if it is possible to previously perform Ahead-Of-Time (AOT) compilation for only the class library code and to use the compiled class library when the Java application is executed in the JVM, the performance of a Java platform can be greatly improved. In addition, since the Java application distributed in Java class file format can be executed by using an interpreting method in the JVM, it is possible to achieve platform-independency of the Java.

In order to achieve platform-independency, the present invention provides a machine coded (m-class) file having the same characteristics and contents as the Java class file. The m-class file is different from a conventional class file in that it has a machine code for a particular target machine instead of a hardware-neutral Java bytecode. In addition, the present invention provides an Ahead-Of-Time (AOT) compiler which creates the m-class file by compiling solely input class files instead of all classes. Thus, it is possible to obtain a class library which is compiled into a machine code suitable for a target machine by the AOT compiler.

According to an exemplary aspect of the present invention, there is provided a Java execution device comprising an extended class library which includes a class file of a machine code obtained by precompiling a class file included in a standard class library and a Java Virtual Machine (JVM) which executes the class file of the machine code class file or an application file included in the extended class library.

According to another exemplary aspect of the present invention, there is provided a configuration of a Java class file, wherein the Java class file comprises a constant, a field, and a method, and method information of the method Comprises an attribute of a code formed of the machine instruction having the operand in which the symbolic reference information is inserted.

According to yet another exemplary aspect of the present invention, there is provided a method of precompiling a Java file, the method comprising converting a Java class file or a Java source file into a machine instruction including an operand in which symbolic reference information is inserted.

According to yet another exemplary aspect of the present invention, there is provided an execution method in a Java Virtual Machine (JVM), the execution method comprising determining whether method information of a method to be executed includes an attribute of a code formed of a machine instruction having a operand in which symbolic reference information is inserted and if the method information of the method to be executed includes the attribute of the code formed of the machine instruction, linking the symbolic reference information with an address and executing the machine instruction.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a conceptual view for explaining a general procedure of executing a Java program;

FIG. 2 is a conceptual view of a hierarchical structure of a general Java program;

FIG. 3 is a view of a first example of a conventional Java platform;

FIG. 4 is a flowchart showing an operating procedure of the first example of the Java platform in FIG. 3;

FIG. 5 is a view of a second example of a conventional Java platform;

FIG. 6A is a conceptual view of a procedure of compiling an application source file according to the present invention;

FIG. 6B is a conceptual view of a procedure of compiling a library source or a class file according to the present invention;

FIG. 6C is a view for explaining a symbolic reference in an operand of a machine instruction of a machine coded class (m-class) file according to the present invention;

FIG. 7 is a view of an example of a configuration of a Java platform according to the present invention;

FIG. 8 is a flowchart showing a procedure of executing a method in the Java platform of FIG. 7;

FIG. 9 is a flowchart showing a procedure of compiling an input class file into an m-class file according to the present invention;

FIG. 10 is a view of a configuration of an m-class file according to the present invention;

FIG. 11 is a view of a configuration of an mcode_attribute of FIG. 10;

FIG. 12A is a view of a common format having a symbolic reference in an operand of a machine instruction of an m-class file according to the present invention;

FIG. 12B is a view of a format having a symbolic reference to constant pool symbols of the common format of the symbolic reference shown in FIG. 12A;

FIG. 12C is a view of a format having a symbolic reference to a JVM-internal symbol of the common format of the symbolic reference shown in FIG. 12A;

FIG. 12D is a view of a format having a symbolic reference indicating a location in a data block of the common format of a symbolic reference shown in FIG. 12A;

FIG. 13 shows types of the constant pool symbols of FIG. 12B;

FIG. 14 shows an indicator of the JVM internal symbol of FIG. 12C; and

FIG. 15 shows test results used to compare performances of a conventional ORP platform and an m-ORP platform of the present invention.

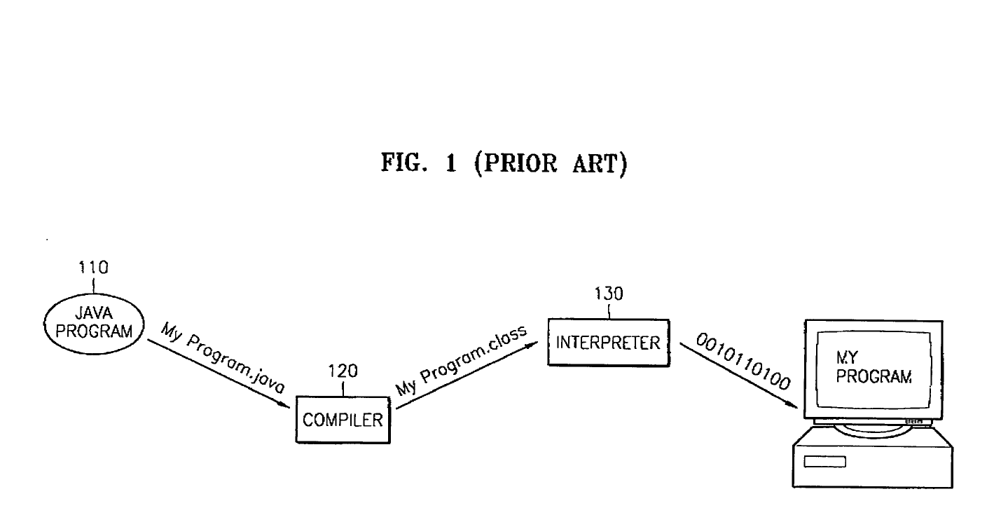

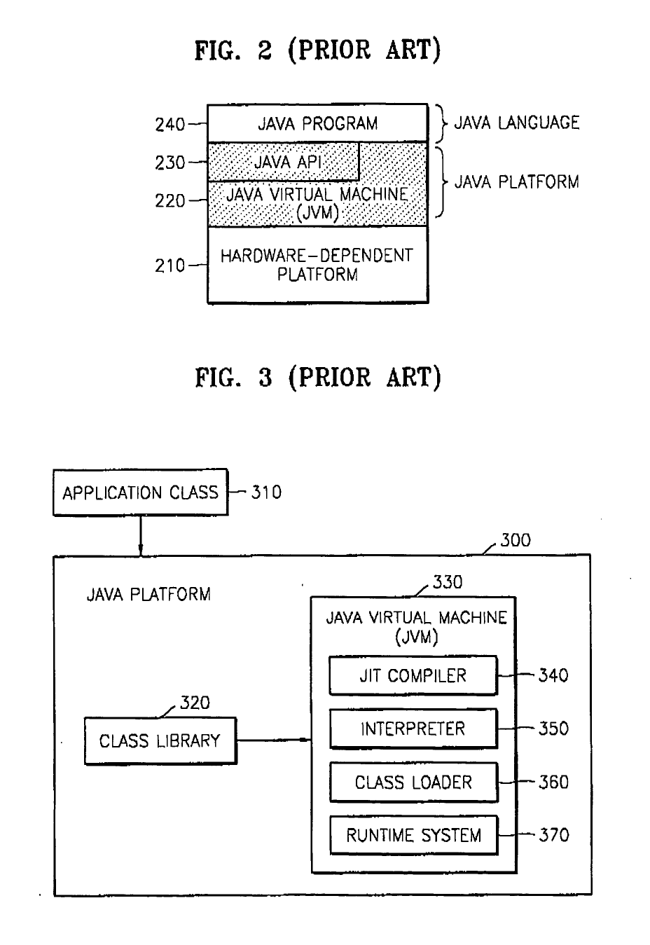

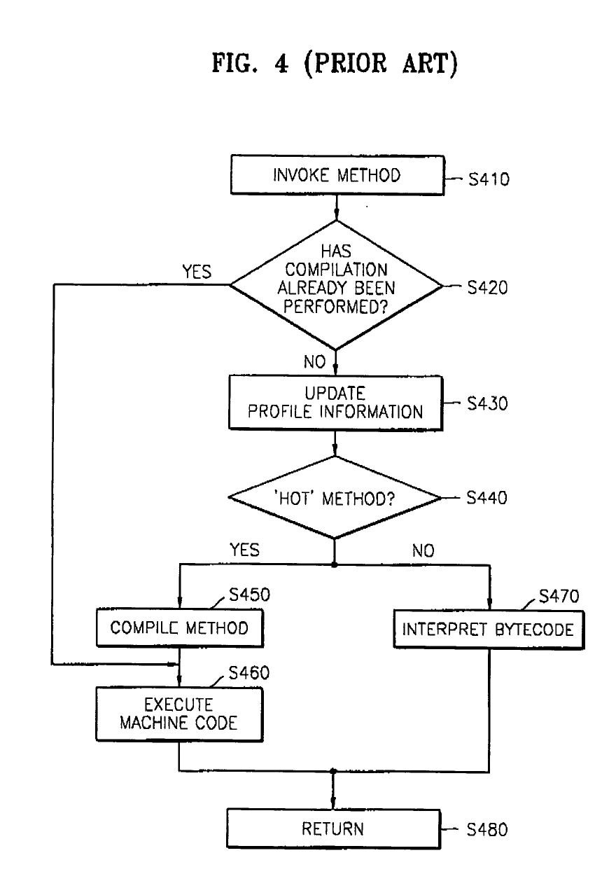

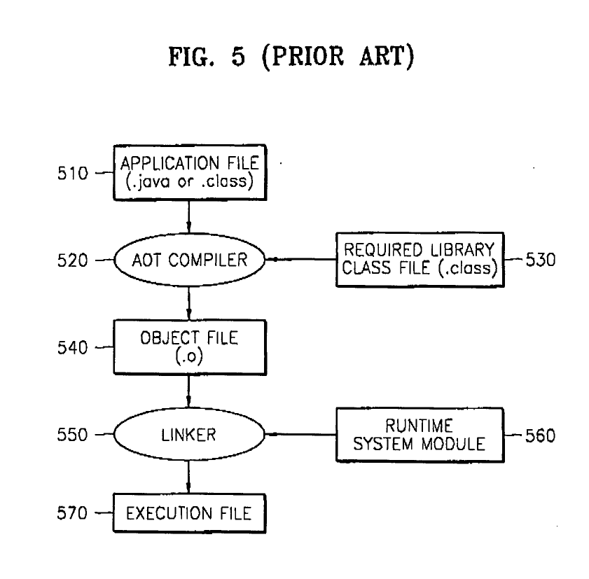

### DETAILED DESCRIPTION OF THE INVENTION

The present invention will now be described more fully with reference to the accompanying drawings, in which illustrative, non-limiting embodiments of the invention are shown.

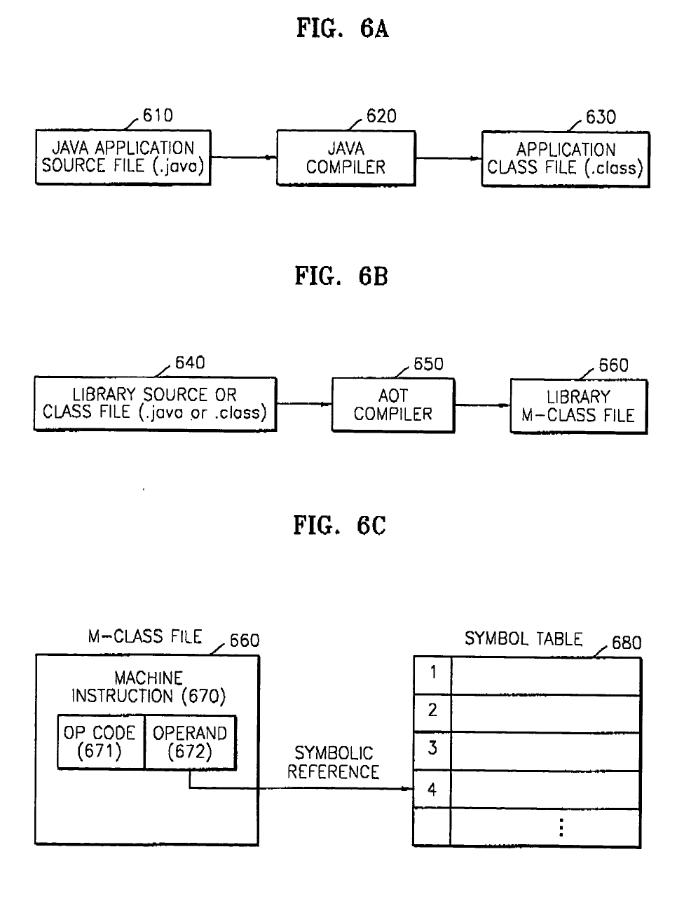

FIG. 6A is a conceptual view of a procedure of compiling an application source file 610 according to the present invention, and FIG. 6B is a conceptual view of a procedure of compiling a library source or a class file 640 according to the present invention.

As shown in FIG. 6A, the Java application source file (.java) 610 is compiled into an application class file (.class) 630 by a Java compiler 620.

As shown in FIG. 6B, the library source or the class file (.java or class) 640 is compiled into a machine coded class (m-class) file 660 by an Ahead-Of-Time (AOT) compiler 650.

As shown in FIG. 6C, the m-class file 660 includes a machine instruction 670. The machine instruction 670 consists of an OP code 671 and an operand 672. If the operand 672 is an address of a symbol, the address of the symbol is replaced by a symbolic reference to a symbol table 680 in which indices and other information are encoded.

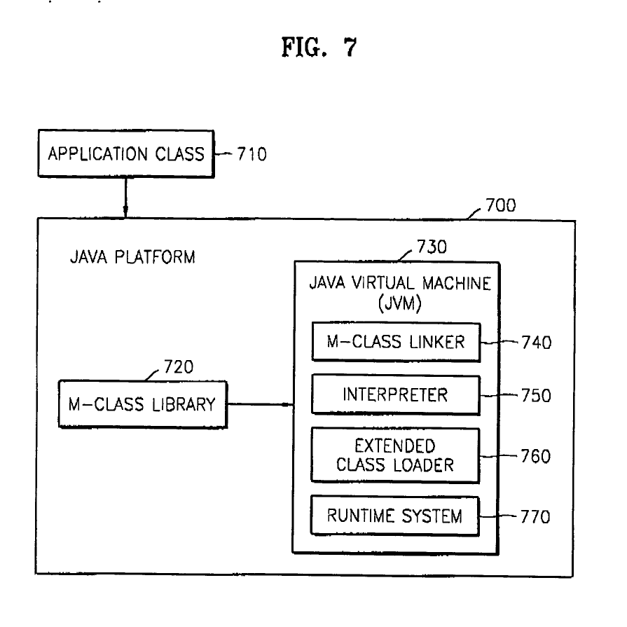

FIG. 7 is a view of a Java platform 700 according to the present invention.

The Java platform 700 includes an m-class library 720 and a Java Virtual Machine (JVM) 730. The JVM 730 includes an m-class linker 740, an interpreter 750, an extended class loader 760, and a runtime system 770.

Here, the m-class library 720 consists of only an m-class file compiled by the AOT compiler 650. However, the m-class library 720 may include a standard class file as well as the m-class file.

The m-class linker 740 interprets information on mcode_attributes of a method of the m-class file included in the m-class library 720 and converts interpreted information into an executable machine code. The interpretation and conversion are mainly comprised of converting a symbolic reference, which is inserted by the AOT compiler 650 in the machine code, into an address of a symbol. In addition, the m-class linker 740 decodes information, which is used to handle exceptions or perform garbage collection, from the information on the mcode_attributes and converts the information into data available by the JVM 730. The extended class loader 760 is extended so that not only the standard class file but also the m-class file can be processed. The interpreter 750 is the same type as an interpreter of a conventional JVM and processes a class file which is not precompiled into the m-class file. Also, a Just-In-Time (JIT) compiler can be used as the interpreter 750. The runtime system 770 is the same type as that of the conventional JVM and can process the m-class file.

An application class 710 is loaded by the extended class loader 760 of the JVM 730, and information on the application class 710 is stored in a data structure of the runtime system 770. A main method, as a first method of a Java application, is transferred to the m-class linker 740 or the interpreter 750 and is executed.

FIG. 7 shows a case when a library (the m-class library 720), which is installed beforehand in a target machine, consists of an m-class file, and the Java application is a standard Java class file. However, the library may comprise the standard class file as well as the m-class file. In addition, if a target processor to be executed has already been known to a user, the Java application can be distributed after being converted into the m-class file. In FIG. 7, since the Java application is distributed in class file format, the main method is transferred to the interpreter 750 and is executed in the interpreter 750. However, if the Java application is distributed in m-class file format, the main method is transferred to the m-class linker 740 and is executed in the m-class linker 740.

Hereinafter, a procedure of generating the m-class file included in the m-class library 720 and a configuration of the m-class file will be described.

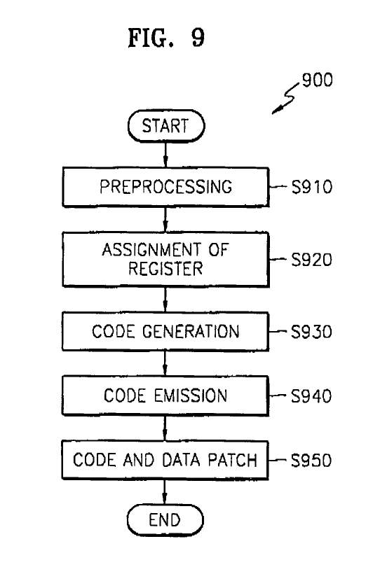

FIG. 9 is a flowchart 900 showing a procedure of compiling the class file into the m-class file.

An AOT compiler according to the present invention independently compiles each method of the class file input to itself.

First, information used to assign a register to a local variable and to perform garbage collection is collected and is preprocessed while scanning all Java bytecodes of the methods (step S910).

Next, the register is assigned to a local variable based on the information obtained in step S910 (step S920).

In a code generation step (step S930), a sequence of instructions from a target machine, which corresponds to each Java bytecode, is generated. Here, symbolic reference information, instead of an address of a symbol, is inserted in an operand of the sequence of the instructions.

In a code emission step (step S940), the sequence of the instructions generated in step S930 is stored in a contiguous memory space.

In the code generation step (step S930), instructions having the need for a patch, e.g. forward references, can be generated. However, in a code and data patch step (step S950), such instructions and contents of a data block are patched. In the same way as step S930, the symbolic reference information, instead of the address of the symbol, is inserted in the operand of the sequence of the instructions in step S950. After AOT compilation has been completed by the AOT compiler, an m-class file formed of machine instructions is created.

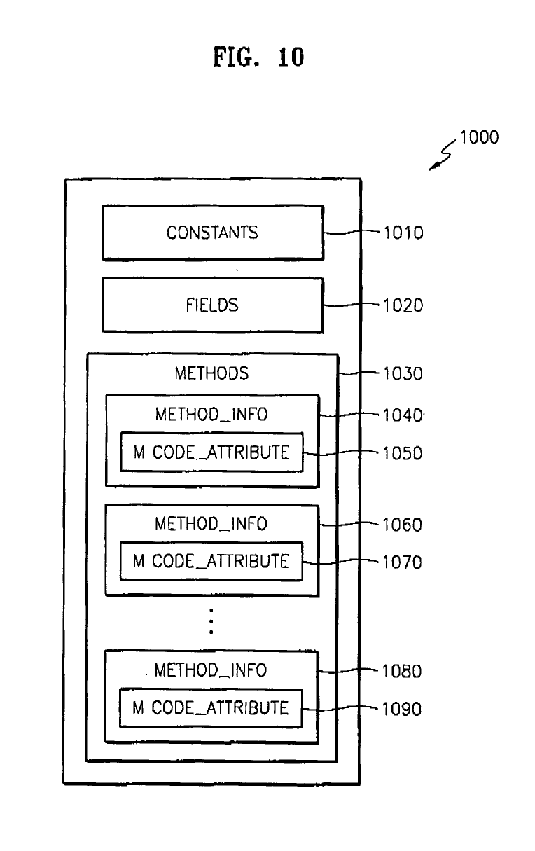

Hereinafter, a configuration of an m-class file 1000 will be described with reference to FIG. 10.

The m-class file 1000 is used to store results of the AOT compilation according to the present invention.

An m-class file format 1000 is an extended format of a standard Java class file prescribed in a JVM specification. The m-class file 1000 includes constants 1010, fields 1020, and methods 1030. Method information (method_info) 1040 of the methods 1030 includes an mcode_attribute 1050. The mcode-attribute 1050 is a user-defined property having a name of “com.samsung.mcode” and contains the results of an AOT compilation. This user-defined property corresponds to an attribute of “Code” of a standard class file specification and includes machine code information and other execution information instead of information on Java bytecodes. The m-class file 1000 is characterized in that this user-defined attribute is substituted for the attribute of “Code” or is included in the m-class file 1000 in addition to the attribute of “Code”. The name of “com.samsung.mcode” expressed by using a uniform resource locator (URL) format complies with rules of naming the user-defined attribute, prescribed in a class file specification. If the m-class file 1000 includes the user-defined attribute having the name of “com.samsung.mcode” as well as the attribute of “Code”, it completely complies with the standard class file specification. That is, although a JVM cannot recognize and use special information on the m-class file 1000, it can execute the m-class file 1000 by loading the m-class file 1000 in standard class file format.

The mcode_attribute 1050 corresponds to a code attribute of the standard class file and includes instructions of a target processor, instead of Java bytecodes, and other information for execution of the Java application.

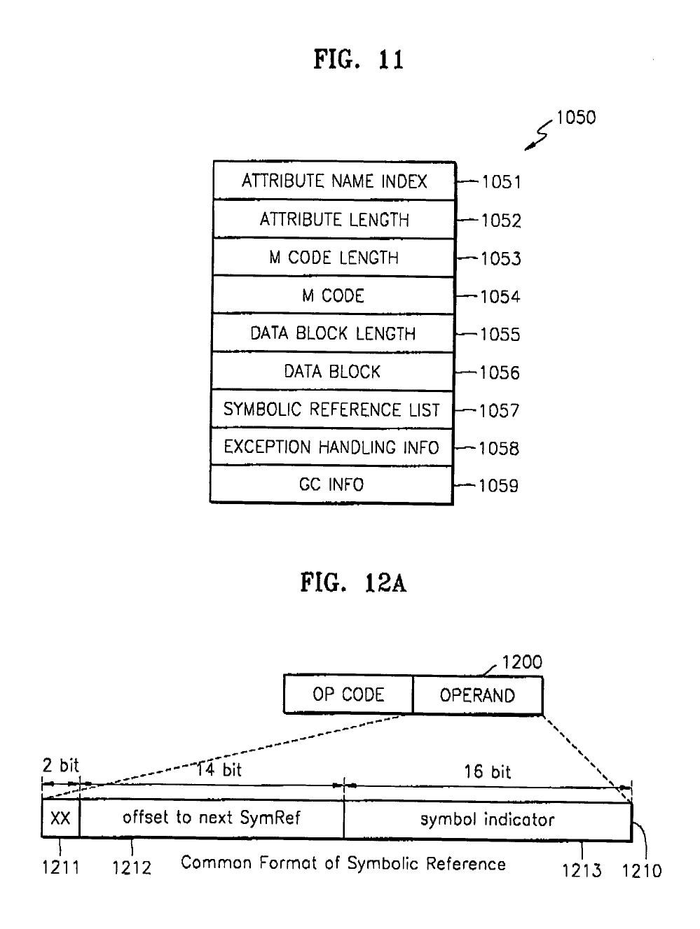

FIG. 11 shows an example of the mcode_attribute 1050, and the configuration of the mcode_attribute 1050 complies with an attribute format prescribed in a class file specification.

In accordance with the attribute format of the class file specification, the mcode-attribute 1050 includes a portion corresponding to an execution code and a portion storing data information.

An attribute name index 1051 represents a name of an attribute; an attribute length 1052 represents the length of all attributes; and an mcode length 1053 represents the length of an mcode 1054.

Instructions of a target processor having Java bytecodes compiled by an AOT compiler according to the present invention are stored in the mcode 1054, and a format of the instructions is partially changed such that a symbolic reference, instead of an address of a symbol, is used for an operand of the instructions. The mcode 1054 needs to be processed by using symbol resolution or the like before it is actually executed in the target processor.

A data block length 1055 represents a length of a data block 1056, and the data block 1056 stores a floating decimal value or a branch table.

A symbolic reference list 1057 includes information on locations of symbols included in codes and data.

An exception handling info 1058 includes information used to handle exceptions, and a GC (garbage collection) info 1059 includes information used for garbage collection.

The AOT compiler according to the present invention plays an important role of generating a machine code necessary for the execution of a method and the data block 1056 referred to by the machine code during the execution of the method. However, it is not possible for the AOT compiler to completely execute its functions without the need for Java bytecodes, and thus, additional information has to be collected and stored in an m-class file.

The information used to handle exceptions has to be stored in the m-class file as the additional information, because, when exceptions occur, it is necessary for a JVM to change an execution procedure by searching for an accurate location of an exception handler while performing stack unwinding. The exception handling info 1058 stores such information used to handle exceptions.

Secondly, type information in stacks used to handle garbage collection is required. A Java bytecode includes type information of an operand, but the type information of the operand is lost after the Java bytecode is converted into machine code. However, the type information of the operand is required when GC is generated. Such type information is stored in the GC info 1059.

The configuration of the m-class file 1000 of FIG. 10 and the configuration of the mcode_attribute 1050 of FIG. 11 are only examples of formats in which the results of AOT compilation are stored, and it can be fully understood by those skilled in the art that the present invention is not limited to such exemplary formats.

In order to give the m-class file 1000 the same characteristics as a Java class file, dynamic links with all symbols should be allowed in the m-class file 1000 in the same manner as the Java class file. It is possible for the Java class file to have the dynamic links with all symbols because the Java class file uses a symbolic reference to indicate fields and methods of an object of the Java bytecodes. Therefore, although the Java class file is AOT compiled into a target machine code, it is possible to implement a dynamic loading/linking of Java if the symbolic reference is used to indicate the fields or the methods of the object in the operand of instructions of the target machine code.

The target machine code included in the m-class file 1000 uses a symbolic reference instead of an address of a symbol to indicate a specific field or method, and a format of instructions of the target machine code can be changed so that symbolic reference information can be inserted in the instructions of the target machine code. The instructions including the symbolic reference information are patched by using an address of a symbol of a JVM and are converted into an execution code. In order to make it possible for the JVM to recognize and use the m-class file 1000, each symbolic reference has to be converted into an address and another process has to be performed during the execution of the Java application. However, since the conversion of the symbolic reference and another process are simpler than JIT compilation, it is possible to obtain a machine code that is more optimal than a machine code obtained by using JIT compilation, and thus, the Java platform can show an improved performance.

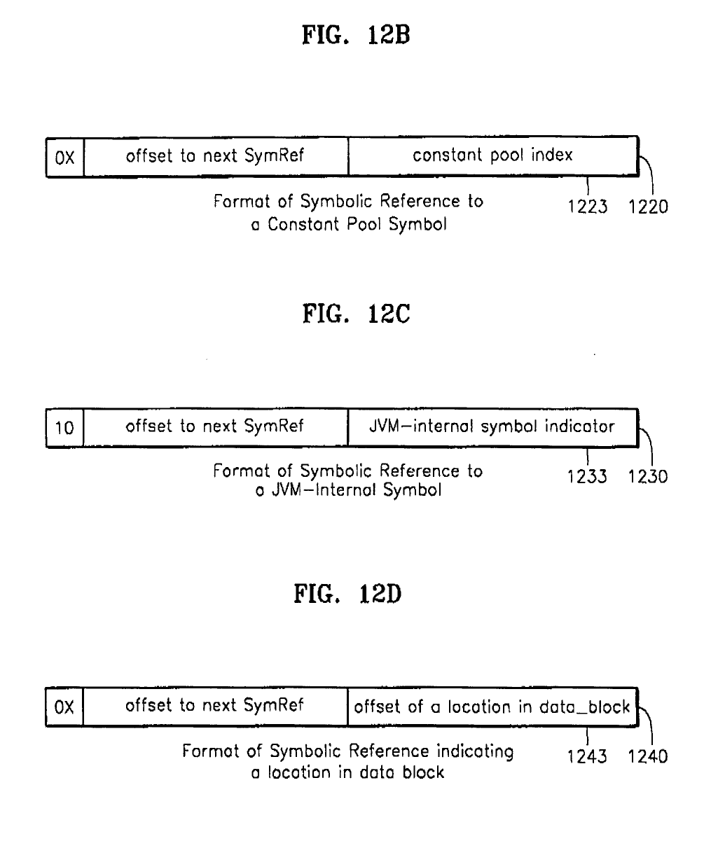

The AOT compiler according to the present invention encodes all symbolic references 1210 into a 32-bit format, i.e., a common format of the symbolic references 1020, as shown in FIG. 12A and folds encoded symbolic references 1210 in an operand of an instruction 1200.

If the operand of the instruction 1200 having a format of x86 corresponds to an address of a symbol, the operand occupies 32 bytes, and thus, the symbolic references 1210 encoded into the 32-bit format can be folded in the operand of the instruction 1200. However, if the AOT compiler is used for another processor, the common format of the symbolic references 1210 may be changed in accordance with the specific instructions of the processor.

In the common format of the symbolic references 1210, a first 2-bit segment 1211 is used as a flag indicating each type of the symbolic references 1020. A next 14-bit segment 1212 is used as a link connecting all symbolic references 1210 and ranges from a first byte following a last byte of a current symbolic reference to a first byte of a symbolic reference following the current symbolic reference. A remaining 16-bit segment 1213 includes a value used to find out a symbol that the current symbolic reference indicates.

Symbols used in codes can be classified into three types, that is, symbols included in a constant pool (constant pool symbols) as shown in FIG. 12B, symbols included in an internal area of a JVM (JVM-internal symbols) as shown in FIG. 12C, and information on a particular location in a data block as shown in FIG. 12D.

The constant pool is a symbol table included in a class file and has information on all symbols used in Java bytecodes. The Java bytecodes use an index of a constant pool entry as the operand to indicate fields or methods of an object. If the operand is a class, a field, or a method in the constant pool, the AOT compiler also uses a symbolic reference having an index 1223 of the constant pool entry, instead of addresses of the class, the field, or the method.

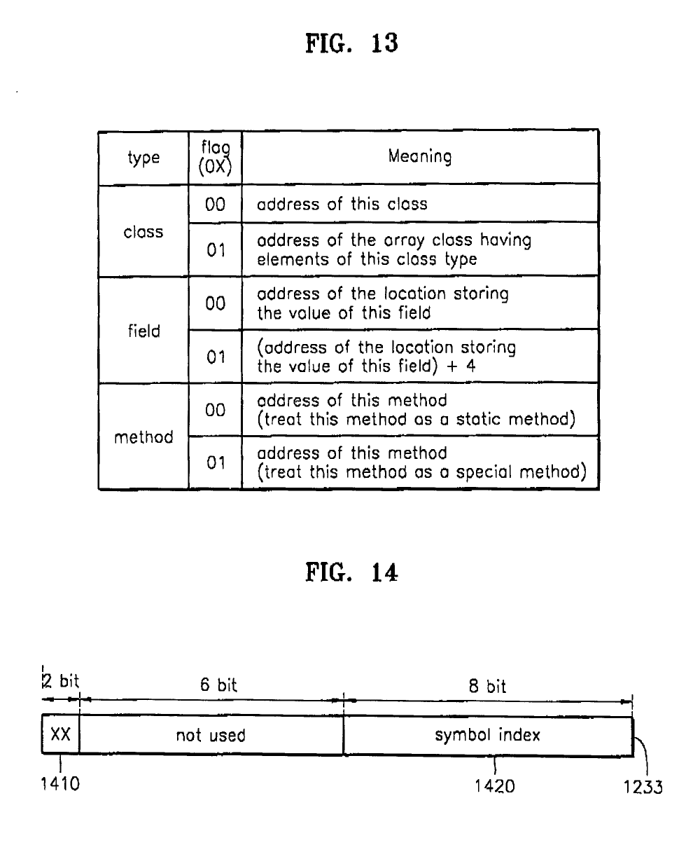

The types of symbols can be determined by using the constant pool entry. The types of symbols used in the AOT compiler are the class, the field, and the method. Each of them can be used in two ways, and thus 6 symbolic references can be used as shown in FIG. 13.

All symbolic references to the JVM-internal symbols are shown in FIG. 12C, and a 16-bit constant pool index 1233 is encoded based on types of the JVM-internal symbols. FIG. 14 shows a configuration of a JVM-internal symbol indicator 1233. A first 2-bit segment 1410 is a flag indicating types of the JVM internal symbols, and a last 8-bit segment 1420 has indices of the JVM internal symbols.

There are various JVM internal symbols used in codes generated by the AOT compiler that can be classified into four types. The first type is a supporting function during execution of the Java application, where an index obtained by creating a table for the supporting function is previously stored in a symbol index 1420 of FIG. 14. The second type is a pre-loaded class such as “java.lang.class” or a native class which is previously loaded in an internal area of the JVM, although it is not included in a constant pool of a class file being compiled. Such pre-loaded class is indicated by using an index obtained by creating a table for the pre-loaded class. The third type is a local variable included in the JVM. The fourth type is used to store another symbol or a hint to be given to an m-class linker.

In a case where a particular location of a data block is designated by an instruction, a general instruction has an address of the particular location as an operand. However, the AOT compiler has a symbolic reference instead of the address as the operand. The symbolic reference is shown in FIG. 12D. A last 16-bit segment 1243 of FIG. 12D is used to store the length of a data block from the beginning to the end.

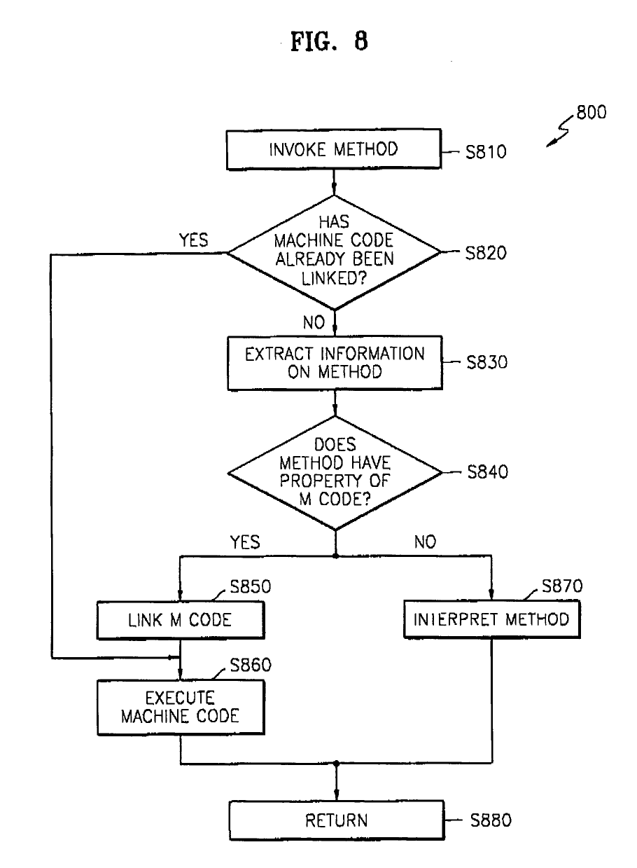

FIG. 8 is a flowchart 800 showing a procedure of executing a method in a Java platform according to the present invention.

If the method is invoked in step S810, it is determined whether the method has already been linked by the m-class linker or is linked and executed for the first time (step S820).

If the method has been executed before, a machine code, which has been generated before, is executed in step S860.

If the method is executed for the first time, information on the method is extracted in step S830, and it is determined whether the method has an mcode attribute in step S840. If the method has the mcode attribute, the m-class linker performs symbol resolution and links the mcode in step S850, and executes the machine code in step S860. If the method does not have the mcode attribute, the method is interpreted by an interpreter in step S870.

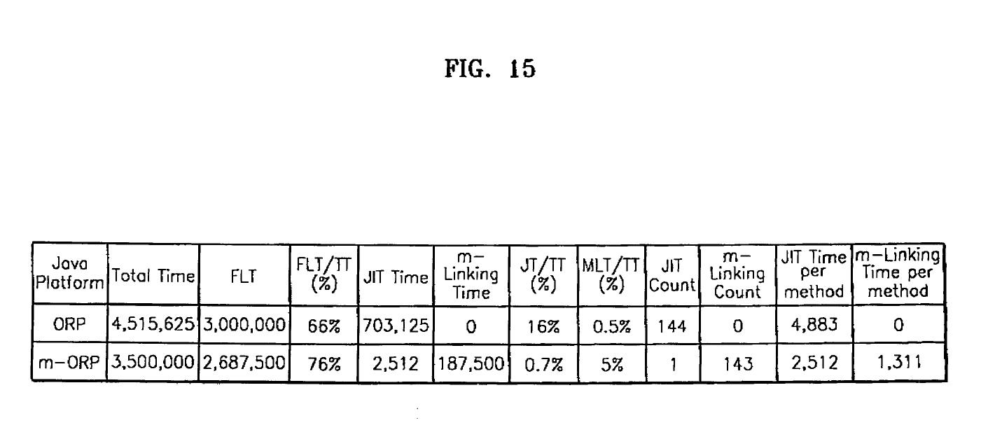

Hereinafter, simulation results according to the present invention will be described with reference to FIG. 15.

FIG. 15 shows comparison results of comparing operating speeds of a general ORP platform and an m-ORP platform according to the present invention. Both the ORP platform and the m-ORP platform were tested in a Pentium IV computer in which Windows XP Professional is installed as an operating system. Values shown in the table of FIG. 15 are obtained by averaging values after repeating a “Hello world” application ten times. In FIG. 15, FLT denotes a file loading time; TT denotes a total time; JT denotes a JIT compilation time; and MLT denotes an m-linking time.

In the comparison results, it is notable that the FLT occupies more than 60% of the total execution time. This result is due to the reduction of JT from improvements in the operating speed of a personal computer (PC), i.e, the Pentium IV computer, while it takes a relatively long time to input/output a disc for file loading. However, since an embedded device does not use a disc generally, the rate of time required to input/output the disc is much slower than the value shown in FIG. 15. In other words, the rate of time required to input/output the disc is extremely great in the comparison results of FIG. 15, so that a difference between the JT and the MLT cannot have a great influence on a performance of a Java platform. However, in the embedded device, the performance of the Java platform may be greatly affected by the difference between the JT and the MLT.

In this comparison, the JT is four times the MLT, and the performance of the Java platform is improved by 20% due to this difference between the JT and the MLT. Considering that this comparison is performed in a PC, the performance of the Java platform in the embedded device can be improved by 80% because the time required to input/output the disc for file loading is excluded.

According to the present invention, it is possible to execute a Java program at a speed higher than in prior art using JIT compilation to execute a method in a Java Virtual Machine (JVM). Since JIT compilation is performed when executing a Java application, JIT compilation is limited by available resources or time. Thus, an optimizing operation cannot be adequately performed when JIT compilation is performed. For this reason, codes generated by a JIT compiler are generally not of high quality. However, since AOT compilation according to the present invention is performed before the distribution of a library class file or an application class file, it is possible to adequately perform the optimizing operation and to create a machine code of high quality unmatchable with JIT compilation. The machine code generated by the AOT compilation has to be post-processed by the JVM when the Java application is executed, so that it becomes available. However, since post-processing is much simpler than JIT compilation, an overhead generated during the execution of the Java application is very small. Therefore, it is possible for the Java platform according to the present invention to show a rapid operating speed when the Java application is executed in a target machine.

In addition, requirements for Random Access Memory (RAM) in AOT compilation according to the present invention are much less than for JIT compilation, which indicates that an embedded device, which has limited RAM and cannot use JIT compilation, can adopt the present invention. In particular, since the embedded device having limited resources, e.g. limited memory, cannot use JIT compilation, it uses an interpreting method, although a Java platform is installed in the embedded device. It is well known that the interpreting method executes the Java application at a speed much slower than JIT compilation. The Java platform according to the present invention shows improved performance compared to JIT compilation. If the Java platform according to the present invention is applied to the embedded device which cannot use the JIT compilation due to its limited resources, the Java platform can show the improved performance.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A Java execution device comprising:
an extended class library which includes a class file of a machine code obtained by precompiling a class file included in a standard class library; and
a Java Virtual Machine (JVM) which executes the class file of the machine code class file or an application file included in the extended class library.

2. The Java execution device of claim 1, wherein a machine instruction of the machine code includes an operand in which symbolic reference information is inserted.

3. The Java execution device of claim 2, wherein the Java Virtual Machine (JVM) includes a class linker which converts the symbolic reference information inserted in the operand of the machine instruction into an address.

4. A configuration of a Java class file, wherein the Java class file comprises a constant, a field, and a method, and method information of the method comprises an attribute of a code formed of the machine instruction having the operand in which symbolic reference information is inserted.

5. The configuration of the Java class file of claim 4, wherein the method information further comprises at least one of exception handling information and information used for garbage collection.

6. The configuration of the Java class file of claim 4, wherein the symbolic reference information comprises at least one of information on a constant pool symbol, information on a Java Virtual Machine (JVM)-internal symbol and information on a location of a data block.

7. A method of executing a Java application, the method comprises:
(a) precompiling a class file included in a standard class library into an extended class library file including a machine instruction;
(b) the extended class library file executing the machine instruction; and
(c) executing a Java application file by using at least one of a Just-In-Time (JIT) compiling method and an interpreting method.

8. The method of claim 7, wherein step (a) further comprises inserting symbolic reference information into an operand of the machine instruction.

9. The method of claim 8, wherein step (b) further comprises converting the symbolic reference information inserted in the operand of the machine instruction into an address.

10. A method of precompiling a Java file, the method comprising converting a Java class file or a Java source file into a machine instruction including an operand in which symbolic reference information is inserted.

11. The method of claim 10, wherein the Java class file comprises a standard class file included in a standard Java class library.

12. An execution method in a Java Virtual Machine (JVM), the execution method comprising:
determining whether method information of a method to be executed includes an attribute of a code formed of a machine instruction having a operand in which symbolic reference information is inserted; and
if the method information of the method to be executed includes the attribute of the code formed of the machine instruction, linking the symbolic reference information with an address and executing the machine instruction.

13. The method of claim 12, wherein, if the method information of the method to be executed does not include the attribute of the code formed of the machine instruction, the execution method further comprises one of Just-In-Time (JIT) compiling and interpreting the method.
